(19) United States
(12) Patent Application Publication
(10) Pub. No.: US 2021/0214887 A1
(43) Pub. Date: Jul. 15, 2021

(54) IMPROVED WATER REPELLENT SUBSTRATE AND APPLICATION METHOD THEREFOR

(71) Applicant: Xefco Pty Ltd, Lilyfield, New South Wales (AU)

(72) Inventors: Thomas HUSSEY, Lilyfield, New South Wales (AU); Zhiqiang CHEN, Belmont, Victoria (AU); Christopher James HURREN, Winchelsea, Victoria (AU); Weiwei LEI, Grovedale, Victoria (AU)

(21) Appl. No.: 17/059,363

(22) PCT Filed: May 22, 2019
(86) PCT No.: PCT/AU2019/050503

§ 371 Date: Nov. 27, 2020

(30) Foreign Application Priority Data
May 31, 2018 (AU) 2018901946

(51) Int. Cl. D06M 15/277; B05D 1/00; D06M 14/22; D06M 14/26; D06M 14/24; D06M 10/10; D06M 10/02

(52) U.S. Cl. CPC D06M 15/277; B05D 1/62; D06M 14/22; D06M 2200/12; D06M 14/24; D06M 10/10; D06M 10/025; D06M 14/26

(57) ABSTRACT

A water repellent fibrous substrate comprising a cured hydrophobic coating layer located on the fibrous substrate; and a hydrophobic plasma polymer coating layer located on the hydrophobic coating layer. The hydrophobic plasma polymer layer may be used to protect the cured hydrophobic coating layer on said fibrous substrate from abrasion or general wear.

### TECHNICAL FIELD

The present invention relates to a water repellent substrates and to a method of preparing the same. More particularly, the presently disclosure may relate to a multi-stage coating process and substrate with said coating process applied thereto.

### BACKGROUND

While fibrous substrates such as fibres, yarns and fabrics may exhibit some inherent water repellent properties, in many applications such inherent water repellent properties are generally inadequate.

Water repellency generally means in the art an ability of a substrate to resist water from penetrating into the depth of the substrate. In the case of fibrous substrates, such as fabrics, that translates to resisting water occupying inter-fibre spaces, as well as penetrating into fibres themselves.

In some applications water repellency can be adequately achieved by simply substituting the fibrous substrate for a waterproof material such as a plastic film. However, there are a number of known problems in relation to using a film on a fibrous substrate, particularly in relation to use of said substrate in garments.

However, there are many applications where the need for using a fibrous substrate is paramount. For example, in many textile related applications it is simply not practical to replace fibrous substrates with plastic film.

On that basis, considerable research has been conducted over the years in developing technology for improving the water repellent properties of fibrous substrates.

Further, known water repellency coatings may be quickly degraded and therefore materials coated with such repellency may lose desirable properties and may be required to be replaced more readily. This consumption of resources is not sustainable, and therefore efforts are needed to improve the sustainability of these materials.

Early stage developments led to coating fibrous substrates with wax or paraffin materials. However, while substrates coated with wax or paraffin did exhibit improved water repellency, the durability of that water repellency was relatively poor. Therefore, these substrates are generally insufficient for use in garments or for prolonged use.

With the primary aim of developing more durable water repellent properties, subsequent research efforts gave rise to a variety of more sophisticated compositions for coating substrates. For example, a variety of curable hydrophobic coating compositions based on hyperbranched polymer, dendrimer, silicone or fluorocarbon chemistry were developed.

Despite imparting improved water repellent durability to substrates, even the more sophisticated curable hydrophobic coatings have struggled to maintain water repellent durability under demanding conditions. For example, fabrics treated with such coatings are commonly used in clothing apparel intended for use in wet weather conditions. In use, such clothing apparel is subjected to various physical factors such as abrasion, stretching and/or rubbing. The clothing apparel may also be subjected to washing with various laundry detergents. Under such conditions, the water repellent durability of substrates coated with state of the art water repellent coating compositions remains less than satisfactory.

Accordingly, there remains an opportunity to develop substrates, and in particular substrates, having improved water repellent durability.

Any discussion of the prior art throughout the specification should in no way be considered as an admission that such prior art is widely known or forms part of common general knowledge in the field.

### SUMMARY

### Problems to be Solved

It may be advantageous to provide for a process to coat substrates with an improved coating.

It may be advantageous to provide for a substrate comprising more than one coating.

It may be advantageous to provide for a process to apply a functional coating to a substrate with a protective coating.

It may be advantageous to provide for an improved functionalised coating on a fibrous substrate.

It may be advantageous to provide for a substrate with a polymerised functional coating.

It may be advantageous to provide for a method for coating a substrate using plasma polymerised coatings.

It may be advantageous to provide for a substrate with a coating that has been polymerised by plasma.

It may be advantageous to provide for a functional coating which has improved functionality from polymerisation in plasma.

It may be advantageous to provide for a system or method for altering the functionality of a functional coating.

It may be advantageous to provide for a method of applying a wet coating to a hydrophobic coating.

It is an object of the present invention to overcome or ameliorate at least one of the disadvantages of the prior art, or to provide a useful alternative.

### Means for Solving the Problem

A first aspect of the present invention may relate to a water repellent substrate comprising:
(i) a cured hydrophobic coating layer located on the substrate; and
(ii) a hydrophobic plasma polymer coating layer located on the hydrophobic coating layer.

In one embodiment, the substrate has a plasma treated hydrophilic surface on which the cured hydrophobic coating layer is located.

In a further embodiment, the cured hydrophobic coating layer has a plasma treated hydrophilic surface on which the hydrophobic plasma polymer coating layer is formed.

In yet a further embodiment, the method comprises a step of applying a hydrophobic coating composition to a substrate and curing the hydrophobic coating composition so as to provide the substrate having a cured hydrophobic coating layer thereon.

In yet a further embodiment, the substrate is in the form of fibre, yarn or fabric, and therefore may be considered to be a fibrous substrate.

In yet a further embodiment, the water repellent substrate forms all or part of clothing apparel.

In one embodiment, the invention may further provide for clothing apparel comprising water repellent substrate, the water repellent substrate comprising: a cured hydrophobic coating layer located on the substrate; and a hydrophobic plasma polymer coating layer located on the hydrophobic coating layer.

Another aspect of the present invention may relate to a water repellent fibrous substrate comprising: a cured hydrophobic coating layer located on the fibrous substrate; and a hydrophobic plasma polymer coating layer located on the hydrophobic coating layer.

In one embodiment preferably, the fibrous substrate may be in the form of a fibre, yarn or fabric. Preferably, the fibrous substrate comprises cotton, wool, angora, silk, grass, rush, hemp, sisal, coir, straw, bamboo, pina, ramie, and seaweed, polyamide (nylon), polyester, polyolefin, polyacrylonitrile, polyurethane, aramid, acetate and combinations of two or more thereof. Preferably, the cured hydrophobic coating layer contains hyperbranched-based polymer, dendrimer, silicone-based polymer, fluorocarbon-based polymer, or combinations thereof. Preferably, the hydrophobic plasma polymer coating layer comprises plasma polymerised residues of one or more of hexamethyldisiloxane (HMDSO), hexamethyldisilazane (HMDSN), tetrafluoromethane, octafluorocyclobutane, difluoroacetylene, and hexafluorobenzene (HFB).

In yet another aspect, there may be provided a method of producing a water repellent fibrous substrate, the method comprising: providing a fibrous substrate having a cured hydrophobic coating layer thereon; and plasma polymerising monomer to form a hydrophobic plasma polymer coating layer located on the cured hydrophobic coating layer.

Preferably, the method further comprises a step of subjecting the cured hydrophobic coating layer to a hydrophilic plasma treatment so as to form a hydrophilic surface on which the hydrophobic plasma polymer coating layer may be formed. Preferably, the method further comprises a step of subjecting the cured hydrophobic coating layer to argon or helium plasma treatment, followed by hydrophilic plasma treatment to provide a hydrophilic surface on which the hydrophobic plasma polymer coating layer may be formed. Preferably, the method further comprises a step of applying a hydrophobic coating composition to a fibrous substrate and curing the hydrophobic coating composition so as to provide the fibrous substrate having a cured hydrophobic coating layer thereon.

In yet a further aspect, there may be provided water-repellent substrate comprising; a substrate having an upper surface; a water-repellent coating applied to the upper surface of the substrate; the water-repellent coating having an upper surface; and wherein the upper surface of the water-repellent coating may be formed by a plasma polymerised coating.

Preferably, the substrate may be selected from the group of a; woven, knitted and non-woven. Preferably, the water-repellent coating comprises a first coating and a second coating. Preferably, the water-repellent coating may be formed from with at least two coatings. Preferably, the water repellent coating extends through at least a portion of a structure of the substrate. Preferably, the coating on the first side comprises plasma polymerised residues of one or more of hexamethyldisiloxane (HMDSO), hexamethyldisilazane (HMDSN), tetrafluoromethane, octafluorocyclobutane, difluoroacetylene, and hexafluorobenzene (HFB).

In a further aspect, there may be provided a substrate with a functional coating comprising; a substrate with a first side and a second side; the first and second sides of the substrate having a coating applied thereto, and connected through the substrate; and wherein the coating on the first side of the substrate has at least one of; a higher abrasion resistance, a thicker coating, an improved water-repellency, and a harder finish, relative to the coating on the second side.

Preferably, the functional coating may be a water-repellent coating. Preferably, the coating on the first side may be formed from a coating applied via wet dipping and a coating formed by plasma polymerisation. Preferably, the coating on the first side comprises plasma polymerised residues of one or more of hexamethyldisiloxane (HMDSO), hexamethyldisilazane (HMDSN), tetrafluoromethane, octafluorocyclobutane, difluoroacetylene, and hexafluorobenzene (HFB). Preferably, the substrate may be selected from the group of a; woven substrate, non-woven substrate, and a knitted substrate.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present aims to solve or ameliorate at least one of the technical problems and this may result in one or more advantageous effects as defined by this specification and described in detail with reference to the preferred embodiments of the present invention.

### BRIEF DESCRIPTION OF THE FIGURES

Preferred embodiments of the invention will now be illustrated by way of example only with reference to the accompanying drawings in which:

FIG. 1 illustrates an embodiment of how a contact angle of a droplet on a surface of a substrate can be measured;

FIG. 2A is a schematic illustration of an embodiment of the overall general process used in preparing the water repellent substrate according to the invention;

FIG. 2B illustrates a flowchart of an embodiment for a two-stage processing of a substrate;

FIG. 2C-2F illustrates an embodiment of a substrate at different stages of being processed by the method;

FIGS. 2G illustrates a sectional view of an embodiment of a fibrous substrate without a coating;

FIG. 2H illustrates a sectional view of an embodiment of a fibrous substrate with a first coating;

FIG. 2I illustrates a sectional view of an embodiment of a fibrous substrate with a first coating and second coating applied on the first coating;

FIG. 2J illustrates a sectional view of an embodiment of a fibrous substrate with two plasma polymer coating layers;

FIG. 3 shows an embodiment of a time/temperature ramp used for pre-washing of the substrate;

FIG. 4 shows an embodiment of time/temperature ramp used for a neutralising step after pre-washing of the substrate;

FIG. 5 shows an embodiment of an inductively coupled RF 13.56 MHz low pressure plasma system used for plasma surface pre-treatment;

FIG. 6 shows an embodiment of the water absorption rates of different samples according to the invention; and

FIG. 7 shows an embodiment of the water absorption rates of different samples where plasma coatings were produced on fabrics comprising ECO DRY C0 cured coating.

### DESCRIPTION OF THE INVENTION

Preferred embodiments of the invention will now be described with reference to the accompanying drawings and non-limiting examples.

The present disclosure provides for a water repellent substrate, and more preferably a water repellent fibrous substrate. By being “water repellent” it is meant the substrate resists water from penetrating into the depth of the substrate. For example, where the substrate is as a fabric, it will resist water occupying inter-fibre spaces as well as penetrating into and/or around fibres themselves.

It will be appreciated from the disclosure herein a substrate may be imparted with water repellent properties. Said water repellent coatings may be imparted to at least one substrate through application thereon of specified coating layers. The specified coating layers are preferably functional coating layers, or a layer which allows for the application of a functional layer.

Using the methods described herein to apply coatings to a substrate, particularly a fibrous substrate, have been found to provide said substrate with water repellent properties having enhanced durability. The enhanced durability may be achieved by using a combination of a cured hydrophobic coating and a hydrophobic plasma polymer coating located over the cured hydrophobic coating.

Most notably, the combined use of the cured hydrophobic coating and the hydrophobic plasma polymer coating have surprisingly been found to act synergistically to provide for water repellent durability greater than that imparted by the cured hydrophobic coating or the hydrophobic plasma polymer coating used alone.

The synergistic effect may be provided by the cured hydrophobic coating providing for a relatively thick hydrophobic layer with good coverage over the substrate and the hydrophobic plasma polymer coating acting as a relatively thin tough outer “shell” over the cured hydrophobic coating. The combination of those two coating layers advantageously provides for an overall water repellent coating that exhibits durability greater than the hydrophobic coating layer or hydrophobic plasma polymer layer when used alone to coat the substrate.

In one embodiment, the substrate has a plasma treated hydrophilic surface on which the cured hydrophobic coating layer is located. In a further embodiment, the cured hydrophobic coating layer has a plasma treated hydrophilic surface on which the hydrophobic plasma polymer coating layer is located.

In another embodiment, there is provided a method of producing a water repellent substrate, the method comprising the steps of: (i) providing a substrate having a cured hydrophobic coating layer thereon; and (ii) plasma polymerising monomer to form a hydrophobic plasma polymer coating layer located on the cured hydrophobic coating layer.

In a further embodiment, there is provided a substrate having improved water repellent properties, the substrate comprising:
(i) a substrate having a cured hydrophobic coating layer thereon; and
(ii) a hydrophobic plasma polymer coating layer located on the cured hydrophobic coating layer.

Similarly, the present disclosure may be described as providing a method of producing a substrate having improved water repellent properties, the method comprising:
(i) providing a substrate having a cured hydrophobic coating layer thereon; and
(ii) plasma polymerising monomer to form a hydrophobic plasma polymer coating layer located on the cured hydrophobic coating layer.

In that context, the “improved” water repellent properties is intended to mean improved relative to the substrate absent the specified coating layers.

In the context of the present disclosure, the improved water repellent properties are relative to a substrate (same substrate) absent the cured hydrophobic coating layer and the hydrophobic plasma polymer coating layer.

Those skilled in the art will appreciate that expressions such as “water repellent”, “water resistant”, and “anti-wetting” are commonly used in the art to express the same, or substantially the same, property of a substrate resisting water from penetrating into the depth of the substrate. More generally, water resistant or water repellent substrates will have a lower absorption rate relative to the same substrate without the coatings described herein.

The substrate may be in the form of a fibre, yarn, or fabric. The substrate may include at least one of; woven fibres, non-woven fibres, yarns, and fabrics. If the substrate is formed from woven fibres, non-woven fibres, yarns, and fabrics, the substrate may be a fibrous substrate.

The substrate may be formed from a natural fibres, a synthetic fibres, or a blend of natural and synthetic fibress. The substrate may also be a blend of different natural substrates or a blend of different synthetic substrates.

Natural substrates are generally considered by those in the art to be derived from plant and/or animal species. Examples of natural substrates include cotton, wool, angora, silk, grass, rush, hemp, sisal, coir, straw, bamboo, pina, ramie, and seaweed.

Synthetic substrates are generally considered by those in the art to mean substrates derived from manmade polymer-based materials. Examples of synthetic substrates include polyamide (nylon), polyester, polyolefin (e.g. polyethylene, polypropylene), polyacrylonitrile, polyurethane, aramid and acetate.

In one embodiment, the substrate is a fibre. In that case, the fibre will typically have a diameter ranging from about 5 micron to about 50 micron, or with a linear density of between about 0.5 denier to about 25 denier.

In another embodiment, the substrate is in the form of yarn. In that case, the yarn is comprised of multiple filaments or fibres with a total linear density of between 5 denier and 1000 denier. The yarn may be produced from a combination of the same, or different, natural and/or synthetic fibres or filaments. The yarns may be texturised via different processes known in the art such as air texturing, draw texturing, twisting, covering, coiling or other method to produce suitable handfeel, stretch and/or other properties desired for a particular application.

In another embodiment, the substrate is in the form of a fabric. In that case, the fabric may be produced by a weaving, knitting or non-woven processes. In some embodiments, the fabric is constructed from warp yarns of around 10-70 denier at a density of around 130-250 threads per inch and weft yarns of around 10-70 denier at a density of around 130-250 threads per inch. In one embodiment, at least one of the warp yarns and/or weft may be selected from to group of; polyester, polyamide, an elastomer, cotton, rayon, nylon, cashmere, alpaca, wool, fleece, silk, linen, acrylic, or any other predetermined natural or synthetic yarn. It will be appreciated that while reference is made to a substrate being coated with one or more functional coatings, the substrate may be optionally be a fabric which is coated with one or more functional coatings. While the present disclosure has large utility in relation to fibrous substrates, other substrates which are not fibrous, or include non-fibrous structures can also be treated or processed with the presently disclosed methods.

In other embodiments, the substrate may be in the form of a stretch woven textile comprising a stretchable yarn featuring elastomeric filaments such as elastane that is crimped, twisted or coiled using texturizing methods known in the art with a less stretchable yarn such as polyester.

In yet another embodiment, the substrate may be in the form of a knitted fabric constructed from yarns between 10 and 100 denier using conventional circular knitting, warp knitting or weft knitting or other method. The knitted fabric may knitted on a high gauge knitting machine with a gauge of between 10-20 needles per inch to provide a dense structure with minimal gaps between yarns.

In one embodiment, the water-repellent substrate has a cured hydrophobic coating layer located on the substrate. By the cured hydrophobic coating layer being “located on” the substrate is meant that the coating layer is physically associated with and provides at least a coating layer, or partial coating layer, over the substrate. The hydrophobic coating layer may be in direct or indirect contact with the substrate and, at least in the context of yarns or fabrics, may penetrate within inter-fibre spaces of fibrous substrates. In one embodiment, a membrane or film may be provided between the coating and the substrate.

One or more other coating layers may be disposed between the cured hydrophobic coating layer and the substrate. The term “coating” may be a deposition which substantially covers an area or surface, and need not be a continuous coverage of an area or surface. The substrate may also be subjected to one or more surface treatment processes prior to application of the hydrophobic coating composition that forms the cured hydrophobic coating layer. In one embodiment, the cured hydrophobic coating layer is located directly on the substrate.

In a further embodiment, the substrate has a plasma treated hydrophilic surface on which the cured hydrophobic coating layer is located. It will be appreciated that the hydrophilic layer will preferably transform or revert to a hydrophobic layer after a predetermined period of time. In this way, the hydrophilic nature of the surface will be on temporary such that a superior hydrophobic coating can be maintained. Preferably, the period of time is a matter of minutes to hours.

By the substrate having a plasma treated hydrophilic surface is not intended to mean the substrate has some form of coating layer per se, but rather the surface of the substrate has been molecularly modified through a plasma treatment process which activates the surface of the substrate. As surface activation can last for a short period of time, the plasma activated hydrophilic nature of the surface will degrade over time and revert to substantially the pre-activation functionality or pre-activation physical or functional property. Further detail in relation to that plasma treatment process is provided below.

By the hydrophobic coating layer being “cured” it is meant the coating layer is derived from a hydrophobic coating composition that, after application to the substrate, undergoes a chemical reaction so as to produce a cured hydrophobic coating layer that has a different molecular composition relative to the applied hydrophobic coating composition. For example, a hydrophobic coating composition applied to the substrate may undergo a polymerisation and/or crosslinking reaction so as to form the cured hydrophobic coating layer. Further detail in relation to formation of the cured hydrophobic coating layer is provided below.

At least one embodiment of the present disclosure may advantageously make use of cured hydrophobic coating layers conventionally used in the art to impart water repellent properties to substrates, and more preferably fibrous substrates.

Examples of suitable cured hydrophobic coating layers include those formed of or containing hyperbranched polymer, dendrimer, silicone-based polymer, fluorocarbon-based polymer, and combinations thereof.

Examples of hydrophobic coating compositions for forming hyperbranched polymer or dendrimer-based cured hydrophobic coating layers include EcoDry™ sold by HeiQ™ and Ruco-dry Eco™ sold by Rudulf™. Other hydrophobic coating compositions may be used in accordance with the processes and substrates described herein.

Examples of hydrophobic coating compositions that may be used to form silicone-based cured hydrophobic coating layers include DWR7000 sold by Dow Corning™

Examples of hydrophobic coating compositions that may be used to form fluorocarbon-based cured hydrophobic coating layers include Unidyne TG-5546 sold by Daikin™ and Barrier C6 sold by HeiQ™.

It will be appreciated that any desired hydrophobic coating chemistry may be used to apply at least one hydrophobic coating to a substrate.

In terms of the amount of cured hydrophobic coating applied to the substrate, it is common practice in the art to refer to the weight of cured hydrophobic coating layer per gram of the substrate.

The amount of cured hydrophobic coating layer per gram of the substrate will vary depending on the intended application of the water repellent substrate. Preferably, the thickness of the first coating layer (cured hydrophobic layer) above a surface of the substrate is in the range of 20 nm to 1000 nm in thickness. The first coating layer may also have thicknesses exceeding 1000 nm if desired. The thickness of a further coating applied to the first coating layer is in the range of 10 nm to 100 nm, but more preferably in the range of 10 nm to 50 nm.

In one embodiment, the substrate has an amount of cured hydrophobic coating layer ranging from about 10 mg/g of substrate to about 1000 mg/g of substrate, or from about 10 mg/g of substrate to about 500 mg/g of substrate, or from about 10 mg/g of substrate to about 100 mg/g of substrate. For avoidance of any doubt, the mass of cured hydrophobic coating layer per gram of substrate referred to herein is based on the weight of a dry substrate.

An important feature of the cured coating layer is that it is hydrophobic. Those skilled in the art will appreciate that by being hydrophobic, the cured coating layer facilitates imparting water repellent properties to the substrate.

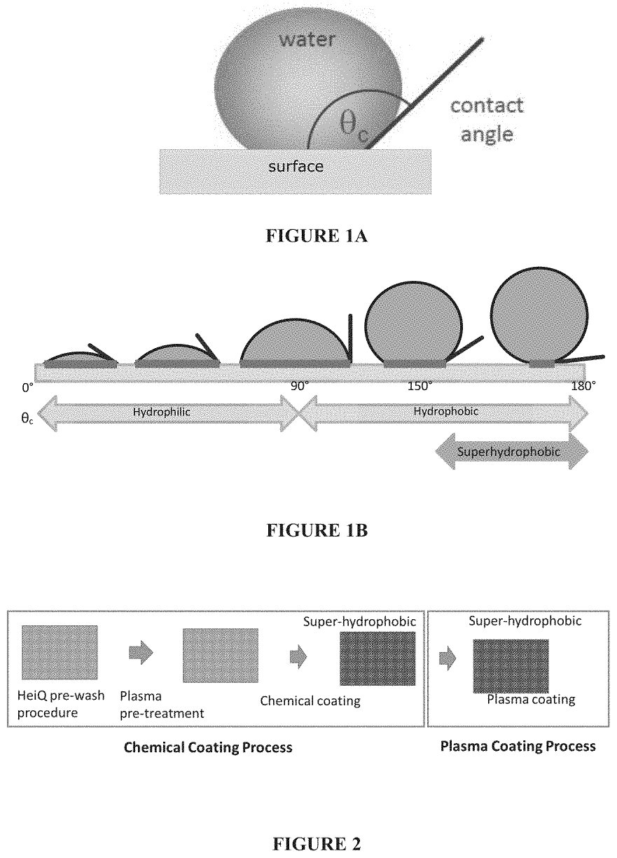

In the art of water repellent substrates, it is common to refer to the contact angle a drop of water makes with the surface of the substrate as an indicator of the substrates hydrophobicity/water repellency. Further detail in relation to the nature of contact angles is presented in FIG. 1.

With reference to FIG. 1A, the contact angle (θc) can be seen to be derived from the surface of the substrate and the edge of a water droplet closest to the substrate surface. FIG. 1B shows how that contact angle varies depending upon the polarity of the substrate surface. For example, a substrate is said to be hydrophilic if the contact angle is less than 90°, whereas the substrate is said to be hydrophobic if the contact angle is greater than 90°. A substrate having a contact angle of at least 150° is known in the art as being superhydrophobic. As such, it is preferred that the contact angle is greater than 90° for as long as possible after application of a water repellent coating to a substrate.

Accordingly, a cured hydrophobic coating layer will provide for a contact angle of a water droplet that is greater than 90°.

Contact angles can be measured using a CAM101/KSV contact angle system using DI water as a probe liquid.

The water repellent substrate preferably has a hydrophobic plasma polymer coating layer located on the hydrophobic coating layer. In other words, if looking at a cross section of the water repellent substrate according to the invention, there would be at least three constituent components, namely the substrate, a cured hydrophobic coating layer located on the substrate, and a hydrophobic plasma polymer coating layer located on the hydrophobic coating layer.

The hydrophobic plasma polymer coating layer may be located directly or indirectly on the hydrophobic coating layer (first coating layer or cured coating layer). For example, there may be one or more other intervening layers located between the hydrophobic plasma polymer coating layer and the cured hydrophobic coating layer, or between the substrate and the cured hydrophobic coating layer.

In one embodiment, the hydrophobic plasma polymer coating layer is located directly on the hydrophobic coating layer.

In a similar manner to that described above in respect of the substrate in the context of the cured hydrophobic coating layer, the cured hydrophobic coating layer may have a plasma treated hydrophilic surface on which the hydrophobic plasma polymer coating layer is located.

As discussed above, such a plasma treated hydrophilic surface of the cured hydrophobic coating layer is not considered to be a coating layer per se, but rather a molecular modification of the surface of the cured hydrophobic coating layer.

Such a plasma treated hydrophilic surface may be provided by conventional means known in the art and is discussed in more detail below.

Hydrophobic plasma polymer coating layers are well known in the art and can advantageously be used. Plasma polymerisation, sometimes referred in the aft as glow discharge polymerisation, uses a plasma source to generate a gas discharge that provides energy to activate or fragment gaseous or liquid monomer often containing a vinyl group, to initiate polymerisation. Polymer formed from this technique is generally highly branched and highly crosslinked and adheres well to substrate surfaces through covalent bonds.

An important feature of the plasma polymer coating layer used is that it is hydrophobic. In a similar manner to that outlined above in respect of the cured hydrophobic coating layer, the plasma polymer coating layer will be considered hydrophobic if it provides for a contact angle of a water droplet of greater than 90°.

The thickness of the hydrophobic plasma polymer coating layer will generally range from about 50 nm to about 200 nm, but may also be as thin as 10 nm.

Examples of hydrophobic plasma polymer coating layers suitable for use may include those comprising plasma polymerised residues of one or more of hexamethyldisiloxane (HMDSO), hexamethyldisilazane (HMDSN), tetrafluoromethane, octafluorocyclobutane, difluoroacetylene, and hexafluorobenzene (HFB).

Water repellent substrates according to the present invention surprisingly not only exhibit excellent water repellency, but that water repellency has been found to be highly durable. By such water repellent properties being durable is meant significant water repellencey is retained after the water repellent substrate is subjected to a harsh testing regime. The testing regime to measure water repellent durability may be a wash tumbling test, details of which is outlined below in the Examples section.

Most notably, it has surprisingly been found that a water repellent substrate according to the present disclosure exhibits improved water repellent durability relative to the same substrate treated with a cured hydrophobic coating layer alone or with a hydrophobic plasma polymer coating layer alone. In other words, using a combination of the cured hydrophobic coating layer and the hydrophobic plasma polymer coating layer according to the present invention synergistically improves durability of the water repellent substrate.

In one embodiment, the cured hydrophobic coating layer provides for a relatively thick coating that can penetrate within inter-fibre spaces of a fibrous substrate or into gaps or pores of a porous substrate. While the cured hydrophobic coating layer is relatively soft, it provides a means to obtain excellent coverage in and around the substrate. The hydrophobic plasma polymer coating layer has been found to adhere exceptionally well to the cured hydrophobic coating layer providing for a secondary hydrophobic barrier for the substrate, particularly when the surface of the cured hydrophobic coating layer is activated. Surface activation of the cured hydrophobic layer can be achieved by plasma treatment or exposure to radiation or a binder agent. While the hydrophobic plasma polymer coating layer is relatively thin, it has been found to provide for an exceptionally tough outer coating and gives rise to an excellent abrasion resistant outer shell. Alone, each of the respective coating layers impart water repellent properties to the substrate. However, in combination, the two coating layers give rise to excellent water repellencey and excellent durability of that water repellencey.

For example it has been found that a water repellent substrate can exhibit water absorption as low as about 15%, whereas the same substrate coated only with the same cured hydrophobic coating layer alone exhibits a water absorption of about 45%.

The method for providing water repellent coatings according to the present disclosure can be performed by providing a substrate having a cured hydrophobic coating layer thereon with a further coating formed by plasma polymerisation techniques. Such coated substrates may be sourced commercially and can advantageously be used.

Where the substrate having a cured hydrophobic coating layer thereon has been sourced commercially, in one embodiment the cured hydrophobic coating layer has a plasma treated hydrophilic surface. While the commercially sourced substrate having a cured hydrophobic coating layer may be provided with that plasma treated hydrophilic surface on the cured hydrophobic coating layer, the method of the present disclosure may further comprise forming that plasma treated hydrophilic surface on the cured hydrophobic coating layer.

In one embodiment, the method comprises plasma treating the cured hydrophobic coating layer so as to form a hydrophilic surface on which the hydrophobic plasma polymer coating layer is to be formed.

Plasma treatment to produce a hydrophilic surface on substrates is well known in the art. Generally, the object to be treated (in this case, the cured hydrophobic coating layer located on the substrate) is placed in a reaction chamber. Pressure in the reaction chamber is typically reduced to produce a vacuum and a precursor gas, such as oxygen, is introduced into the chamber and through the application of energy, the precursor gas ionises to form a plasma. The resulting plasma ions collide with the surface of the substrate causing that surface to undergo oxidation and become hydrophilic in nature.

If desired, prior to subjecting the cured hydrophobic coating layer to plasma treatment to form the hydrophilic surface, the cured hydrophobic coating layer may also be subjected to argon or helium plasma treatment. Argon and helium plasma treatments use argon or helium, respectively, as the precursor gas and have been found to both activate and clean the substrate surface making it more receptive for undergoing hydrophilic plasma treatment. Similar treatments may be applied to the substrate in advance of treating the substrate with an oxygen plasma. It will also be appreciated that the surface of the cured hydrophobic layer may use only argon and/or helium to etch the surface to cause a mechanical bond. Alternatively, only an oxygen plasma treatment may be used to form hydroxyl groups (which are hydrophilic) at the surface, which can more easily form a chemical bond with a further coating. As such, cured hydrophobic layer and/or the substrate may have mechanical bonding regions and chemical bonding regions after respective plasma treatments. It is preferred that a substrate and/or cured hydrophobic layer undergo both an argon (or helium) plasma treatment and an oxygen plasma treatment.

Accordingly, in one embodiment the method comprises subjecting the cured hydrophobic coating layer to argon or helium plasma treatment, followed by hydrophilic plasma treatment to provide a hydrophilic surface on which the hydrophobic plasma polymer coating layer is to be formed.

Alternatively, rather than using a commercial source of substrate having a cured hydrophobic coating layer thereon, the method of the present disclosure may comprise a step of applying a hydrophobic coating composition to a substrate and curing the hydrophobic coating composition so as to provide the substrate having a cured hydrophobic coating layer thereon.

Accordingly, in one embodiment, the method comprises a step of applying a hydrophobic coating composition to a substrate and curing the hydrophobic coating composition so as to provide the substrate having a cured hydrophobic coating layer thereon.

The improved water repellent substrate of the present disclosure may advantageously make use of hydrophobic coating compositions conventionally used in the art that form the required cured hydrophobic coating layer. Examples of such hydrophobic coating compositions include hyperbranched polymer-based compositions, dendrimer-based compositions, silicone-based compositions, fluorocarbon-based compositions and combinations thereof. Such compositions may be provided in the form of a dispersion or solution in an appropriate liquid, for example an aqueous liquid or organic solvent. Specific examples of suitable hydrophobic coating compositions include those herein described, however any desired hydrophobic coating compositions may be used.

Conventional techniques and apparatus can advantageously be used for applying the hydrophobic coating compositions to the substrate.

Examples of techniques for applying the hydrophobic coating composition to the substrate include application by exhaustion, foam, flex-nip, nip, pad, kiss-roll, beck, skein, winch, liquid injection, overflow flood, roll, brush, roller, spray, dipping and emersion.

If required, the hydrophobic coating composition may be applied to the substrate in combination with one or more process additives. Such process additives may include wetting agents.

Once the hydrophobic coating composition has been applied to the substrate it will need to undergo a curing step. The curing step required will vary depending upon the nature of the hydrophobic coating composition. Specific details of the curing step required will be provided by the manufacturer of the coating composition. For example, curing if the hydrophobic coating composition may be promoted through addition of a catalyst or crosslinking agent, typically incorporated in the coating composition prior to application on the substrate, and/or applying heat to the hydrophobic coating composition that has been applied to the substrate.

Where temperature is used to promote curing of the applied hydrophobic coating composition, that temperature will generally range from about 120° C. to about 150° C. The temperature of the plasma for polymerisation and/or pre-treatment may be a cool plasma, with temperatures in the range of 20° C. to 150° C. Other plasma temperatures may be used depending on the desired polymerisation or functionalisation of the coating or the substrate.

If desired, the substrate may be subjected to one or more cleaning steps prior to application of the hydrophobic coating composition. For example, the substrate may be subjected to a washing step. It is preferred that substrates are cleaned prior to being introduced to a plasma treatment. Optionally, ozone cleaning may be used to remove biological contaminants on the surface of the substrate.

In one embodiment, prior to application of the hydrophobic coating composition, the substrate is subjected to one or more washing steps. The washing step will generally involve agitating the substrate in an aqueous liquid comprising a surfactant or detergent. Suitable surfactants are well known in the art. If washing is used, the substrate will be preferably dry or substantially dry in advance of a first coating being applied.

If desired, prior to application of the hydrophobic coating composition the substrate may be subjected to argon and/or plasma treatment and oxygen plasma treatment as herein described. Other plasma gases may also be used, which are preferably formed by inert gases such that coating chemistry is not altered undesirably by plasma fluids. When using oxygen as a plasma gas, the oxygen may be deposited at the surface and react with coatings, which may cause functional coatings to be altered causing a temporary and desired hydrophilicity at a surface.

Both washing and plasma treatment steps (preferably argon plasma) can facilitate effective and efficient application and/or adhesion of the hydrophobic coating composition to the substrate as the fibrous surface has become activated. Surface activation by plasma will generally cause the surface to become, at least temporarily, hydrophilic.

Accordingly, in one embodiment the method comprises subjecting the substrate to plasma treatment prior to application of the hydrophobic coating (pre-treatment) to the substrate. Further, an oxygen plasma may be used to activate or cause hydrophilicity at the surface of the substrate to assist with adhesion or application of a curable hydrophilic coating.

The method according to the present disclosure comprises plasma polymerising of monomers to form a hydrophobic polymer coating layer located on the cured hydrophobic coating layer or an intermediary layer. The intermediary layer can be a layer which was polymerised by a plasma field. In this way multiple layers of functional chemistry can be applied to the substrate or onto other coatings of the substrate. Optionally, layers of different coatings can be applied to a substrate.

Conventional reagents, techniques and apparatus known in the art can advantageously be used in accordance with the invention to form the hydrophobic plasma polymer coating layer. Low pressure and/or atmospheric pressure plasma polymerisation techniques can be employed. Preferably, the method is used with atmospheric plasma techniques and systems.

In one embodiment, plasma polymerising monomer to form the hydrophobic plasma polymer coating layer is conducted at atmospheric pressure. Techniques and equipment for performing atmospheric plasma polymerisation are known in the art. Optionally, after the plasma polymerisation coating is applied, the substrate is introduced into a controlled location to reduce the potential for atmospheric elements or composites from being bonded with the plasma formed polymeric layer.

Monomers that may be plasma polymerised to form the hydrophobic plasma polymer coating layer are known in the art and include hexamethyldisiloxane (HMDSO), hexamethyldisilazane (HMDSN), tetrafluoromethane, octafluorocyclobutane, difluoroacetylene, hexafluorobenzene (HFB) and combinations of two or more thereof. Other monomers may be suitable provided that they can be polymerised by contact with a plasma field.

The water repellent substrate according to the present disclosure may be particularly well suited to forming all or part of clothing apparel and other garments. For example, the water repellent substrate may form all, or part, of clothing apparel selected from recreational or performance swimwear, wetsuits, diving suits, outdoor clothing and sportswear including water resistant jackets, t-shirts, shorts and trousers, footwear as well as other textile goods such as tents, sleeping bags and other equipment. Other uses for the textile may include environmental exposure textiles, such as those used for tents, shades, umbrellas, sails, vehicle textiles, or any other textile which is exposed to UV light or environmental conditions for prolonged periods.

In one embodiment, the water repellent substrate is in the form or fibre, yarn, or fabric. That fibre, yarn, or fabric can be employed in the manufacture of clothing apparel described herein using conventional techniques and apparatus known in the art.

In another embodiment, the process may include the steps of cleaning the substrate. Cleaning methods commonly used for textiles may be suitable for use with the substrate. For example, industrial surfactants and/or agitation techniques may be used to remove matter from the substrate prior to coating treatments. Other cleaning methods may be used, such as surface cleaning with ozone or other sterilant gases.

Once cleaning of the substrate has been completed, an optional plasma pre-treatment may be applied to the substrate in advance of a coating being applied. If more than one coating is to be applied to a substrate, a plasma pre-treatment may be applied in advance of each respective coating. Therefore, plasma pre-treatments may be used to treat a substrate, coating, or layer or film applied to said substrate. Plasma pre-treatments gases may be selected from the group of; oxygen, nitrogen, argon, hydrogen, or another other inert gases. Preferably, an inert gas is used to generate any plasma such that the gases are less likely to bond with the surface of the substrate or coating, layer or film applied thereto. This may allow for surface activation which can either alter the chemistry applied to a substrate or impart a desired property to the surface being activated.

A first coating can be applied to the substrate after the cleaning and optional pre-treatment step. The coating is preferably a functional coating which imparts a functional property to the substrate. The first coating applied can be applied by using a wet dipping process, as is commonly known in the art. This process will typically require the substrate to be submerged, or partially submerged within a functional treatment chemistry. The substrate can then be dried or wringed (typically using a padder) to remove moisture from the dipping process and allow the chemistry on the substrate to cure. Any predetermined curing method may be used to set or otherwise chemically alter the functional coating on the substrate.

Again, a plasma pre-treatment step can be conducted after the application of a first coating, in advance of a further coating being applied. It will be appreciated that more than one further coating can be applied to the substrate.

Further, plasma pre-treatments may be used to clean a surface or alter the functionality of a surface. This is advantageous with respect to activating a functional coating as functional coating properties may be temporarily changed to allow for further coatings or layers to be applied. For example, activating a hydrophobic surface may temporarily alter the hydrophobicity functionality to a hydrophilicity functionality. As such, a hydrophobic coating may have a wet treatment applied thereto more effectively.

Plasma surface functionalisation techniques may be used before and after application of a plasma polymerised coating. Surface functionalisation techniques may temporarily or permanently alter the surface properties of a coating or substrate.

At least one further coating is preferably applied onto the last coating applied, or an activated surface of the first coating. The further coating can be the same as the last coating with regards to functionality and/or chemistry of the last coating applied. The further coating is preferably applied during a polymerisation stage, in which a monomer is polymerised by a plasma and deposited onto the first coating, or the last coating applied. As the further coating is being applied to a coating which has been activated, the further coating will have an increased bonding strength to the coating, compared to when a coating is not activated. By polymerising the further coating at the same time as deposition, or near to the time of deposition, may allow for a hard coating and/or coating with an increased functionality to be formed. The final further coating applied to the substrate preferably provides for at least one of a desired; abrasion resistance, functionality, water repellency, liquid resistance, rigidity and/or breathability. It will be appreciated that the coatings formed on the substrate will preferably have a negligible or small impact on the breathability of the substrate.

The process as disclosed above may be used to generate a laminar coating of functional coatings. The laminations of the coating may all be formed from the same chemistry, which has been modified by plasma treatments or alterations of curing methods. In this way at least one of a desired; rigidity, abrasion resistance, tensile strength and/or compressional strength properties may be imparted to a textile or other substrate.

Preferably, each coating applied has a thickness in the range of 0.1 μm to 100 μm, or more preferably in the range of 0.2 μm to 20 μm. Each coating may have a different thickness or the same thickness, which may impart a desired physical property to the substrate.

Including more than two layers, may have a number of advantages as multiple layers may have superior abrasion resistance or shearing resistance compared to a single coating. In addition, multiple coatings may also be used to sandwich or embed a coating layer, material, pigment, film or fibre therebetween. The above process may be used to produce a substrate which has a first coating on both sides of the substrate (the dipping process will treat both sides of the substrate and fill gaps between the sides) and a further coating on only one side of the substrate, which is deposited on the first coating.

At the interface between the first coating and the further coating, the surface functionalisation may change after polymerisation of the further coating. It will be appreciated that the bond strength between the first layer and the second layer using this method may be superior to that of other methods. Notably, it would not have been obvious to combine a wet dipping method with a secondary plasma polymerisation coating to achieve an improved water-repellent coating.

Using a dipping process in advance of a plasma coating finishing process allows for a functional coating to enter into recesses and gaps between yarns of the substrate, particularly a substrate, which spray coating methods or deposition methods cannot readily achieve. The plasma coating finishing provides for a protective layer, which is also functional. The plasma coating can be used to form a “shell” or barrier which has a relatively higher abrasion resistance than the first coating.

It will be appreciated that applying only one of the first coating and the further coating noticeably reduces the quality of the overall coating compared to the two-stage method of the present disclosure. The two-stage method as described above may provide for a coating method which can increase the expected life of a substrate as functional coatings are retained on the substrate more effectively. Preferably, the further coating is applied to the side of the substrate which is to be the face side of the substrate and therefore is more likely to be exposed to impacts, abrasions or other physical means which can reduce or degrade functional coatings applied.

Optionally, after the further coating has been applied, the substrate is subjected to an atmosphere with a high percentage of the plasma gas, such as argon, which may assist with reducing bonding of oxygen with the further coating. The high percentage of plasma gas may be at least 30% of the overall local atmosphere the substrate is exposed to. It will be appreciated that this step is optional, but may be advantageous for the use of atmospheric plasma systems.

The present invention will hereinafter be described with reference to the following non-limiting examples.

### EXAMPLES

### General Process

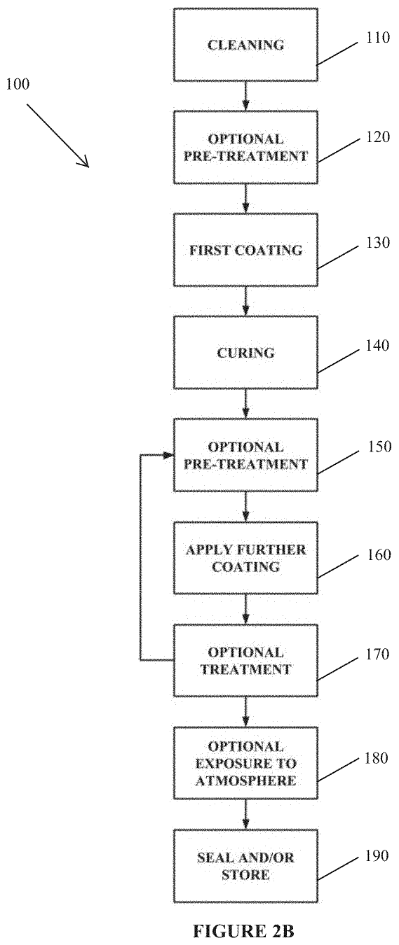

FIG. 2A is a schematic illustration of the overall process used in preparing the water repellent substrate. Base textiles were pre-washed using conventional surfactants and processes known in the art to remove surface finishing oil and waxes prior to a plasma surface pre-treatment and application of the curable hydrophobic coating composition. Following the application of the cured coating, a second plasma surface pre-treatment step was conducted to render the surface of the cured hydrophobic coating layer hydrophilic prior to the application of the plasma polymer coating layer.

FIG. 2B illustrates a flowchart of an embodiment of a two-stage process 100 in which at least two coatings can be applied to a substrate 210. In a first step, the substrate can be cleaned 110 to remove any debris or dirt from the surface in advance of treatment. Optionally, a pre-treatment process 120 can be applied to the substrate. The pre-treatment process can be a surface activation process, which may be achieved by passing the substrate through and/or near to a plasma field. Preferably, the pre-treatment process includes forming hydroxyl groups or hydrophilic groups at the surface. Another pre-treatment process may be application of a polymer layer, such as a polymer layer which can be formed by use of a plasma polymerisation process (see FIG. 2J for example). In yet another embodiment, an adhesive or chemical binder may be applied in the pre-treatment process.

Next a first coating can be applied to the substrate 130. The first coating can be a hydrophobic layer. The first coating can be applied using a dipping process, in which the substrate is submerged in a predetermined functional chemistry (coating fluids). Using a dipping process can allow for penetration of desired chemistry into the structure of the substrate and allows for coating of both sides of the substrate with the first coating chemistry. Excess coating fluids can be removed from the substrate via a padding machine, or any other predetermined or conventional method. The first coating can then be cured 140 to set or solidify the first coating 220 with the substrate 210. After curing of the hydrophobic layer 220 the cured hydrophobic layer can be pre-treated 150 before application of a further coating 230. Suitable pre-treatments may include one or more of an argon plasma treatment, a helium plasma treatment and an oxygen plasma treatment. Preferably, treatments to the first coating etch the surface of the first coating and/or form hydrophilic groups to allow for improved mechanical bonding and chemical bonding with a further coating 230.

After any desired pre-treatment processes have been finished, a further coating can be applied 160 to the cured hydrophobic layer. The further coating applied is preferably a plasma polymer coating. An optional post treatment may be applied to the further coating 170 (plasma polymer coating) which can be used to improve a functional attribute or property of the plasma polymer coating or may clean, undulate or smooth the coating surface(s).

After any treatments have been applied to the further coating layer, the substrate may be entered into a controlled environment 180 which may be rich with a predetermined atmosphere. The predetermined atmosphere may reduce the number of undesired reactions at the surface of the substrate while the plasma polymer layer is completing polymerisation. The coated substrate 200 can then be stored or transported 190.

Referring to FIGS. 2C to 2F, there is show a simplified sectional view of an embodiment of a substrate having coatings applied thereto using the method as disclosed herein. It will be appreciated that the coating layers 220, 230 on the substrate 210 have been emphasised to more easily discern in the representations, and thicknesses of these layers are not to scale. FIG. 2C shows a substrate 210 before application of a first coating. The substrate may be any predetermined substrate, but is preferably a woven, or non-woven substrate and comprises one or more fibres. The substrate 210 can undergo pre-treatment processes to impart a desired property to the substrate, such as imparting hydrophilicity properties.

FIG. 2D illustrates the substrate of FIG. 2C after application of a cured hydrophobic coating 220 or a “first coating” 220. The coating 220 can be applied by a dip coating process and forms a coating on each side of the substrate 210. Pores and gaps in the substrate 210 may also be exposed to and receive the coating during the dipping process/padding process. The coating 220 on each side of the substrate 210, and through the substrate 210, is collectively referred to as a “first coating” 220.

FIG. 2E shows an embodiment of a surface of a first coating 220 which has been activated 225. The surface activation 225 may be achieved by plasma pre-treatment methods and preferably is active at the interface between the first coating 220 and the further coating 230. Surface activation can alter, at least temporarily alter, the surface being activated and impart a desired property. In this embodiment, it is preferred that the first coating 220 is a water-repellent coating which is hydrophobic. At least one plasma treatment may be used for surface activation of the first coating 220 to allow for the surface to become hydrophilic, at least temporarily, such that the application of a further coating 230 can be achieved more readily and improve bonding between the first coating and said further coating 230. Plasma treatments may also be used to etch the activated surface 225 of the first coating 220. The activated surface 225 may age or degrade over time and return to a pre-activation functionality.

FIG. 2F shows a further coating 230 applied to the first coating 220 at the activated interface 225. The further coating 230 being a plasma polymerised coating. Plasma polymerisation will have a higher degree of crosslinking relative to conventional wet dipping processes and will have a higher abrasion resistance in addition to forming a hard coating (or hard shell). It will be appreciated that the further coting may be applied in advance of entering into a plasma field, or may be applied when exposed to the plasma field. Preferably, the plasma polymerises a monomer which is bonded to the first coating 220. In this way the combination of the first coating 220 which extends through the substrate forming a root structure for the further coating. The combination of the substrate 210, first coating 220, and further coating 230 forms the coated substrate 200.

The thickness of the cured hydrophobic coating layer 220 (first coating) may be in the range of 50 nm to 1000 nm from the surface of the substrate 210. The thickness of the plasma polymer coating 230 (further coating) applied to the first coating 220 may be in the range of 10 nm to 100 nm.

Referring to FIGS. 2G to 2I, there is shown an embodiment of a substrate with a weave structure. FIG. 2G is an uncoated substrate comprising yarns made of a plurality of filaments. While further transverse yarns are illustrated in FIG. 2G, these have been omitted in the representations of FIGS. 2H to 2J. FIG. 2H shows the substrate after a wet coating process in which the penetration of the wet coating (first coating 220) generally fills the gaps around the yarns 210A, 210B forming the substrate 210. It will be appreciated that gaps between the yarns 210A, 210B and the first coating 220 may be present after curing, and the wet coating penetration may be dependent on the denier of the yarns and the structure of the weave/knit/braid/non-woven substrate. It will be appreciated that gaps formed between yarns (not shown) extending from one side of the substrate 210 to the other side of the substrate 210 may also be coated by the wet coating, and thereby connect the coatings present on both sides of the substrate 210. The wet coating may form a base or root structure for further coatings to be applied thereon, such as the plasma polymerised coating 230 as seen in FIG. 2I.

The plasma polymerised coating of FIG. 2I shows a non-uniform thickness of the further coating 230. The non-uniform nature of the plasma polymer coating 230 may allow for flexure or movement at the narrow regions of the coating without the thicker portions of the coating being damaged during use. The further coating can be applied by providing a polymer, or monomer to be polymerised, from a single direction. In this example, the polymer coating 230 has been applied form a direction which is perpendicular to the plane of the substrate 210. More than one coating direction may be used to form a desired coating thickness profile and/or density.

Referring now to FIG. 2J, there is illustrated a further embodiment of a substrate 210 which has been coated using the two-stage processing method. In this embodiment, the substrate 210 has undergone a plasma polymerisation coating process in advance of application of a cured hydrophobic coating layer 220. The first plasma polymer coating 240 has been applied directly to the yarns 210A, 210B of a substrate 210. This may allow for a chemical bond to be formed with the yarns in advance of a wet dip process which applies the curable hydrophobic coating layer 220. The polymerised yarns 210A, 210B may be surface treated such that the surface is activated to allow for a chemical bond to occur between the polymer on the yarns and the wet coating. In conventional methods, the coatings applied to yarns via wet coating methods will not form a chemical bond with the yarns, but rather form chemical bonds with itself during curing. This creates a coating which is, at least in part, mechanically bound around or adjacent to yarns (210A, 210B) of a substrate 210, but does not form significant, or any, chemical bonding. As shown, the first plasma polymer coating 240 is deposited as a non-continuous layer, and adheres primarily to the peaks yarns of the structure, which allows for penetration of the curable hydrophobic coating 220 into the substrate 210.

Optionally, recesses between yarns or at the surface of the first coating 220 may not be coated with the further coating 230, such that the peaks of the yarns are capped with the further coating 230. It will be appreciated that the further coating does not need to be a continuous coating, but a coating which is applied to a discrete or predetermined area of the first coating 220 or the substrate 210.

Applying an initial plasma polymerisation coating in advance of a wet coating process may improve the bond between the coatings applied and the substrate. This may further improve the life expectancy of the functional coatings applied, and thereby reduce the need for replacement coatings or replacement of the substrate.

Base Fabric

A stretch woven polyester and elastane textile was used in these experiments with a composition of 86% polyester and 14% elastane and mass per unit area of 142 g/m2. The fabric was constructed from weft yarns comprising 75 denier polyester yarns combined with 40 denier elastane yarns and warps yarns comprising 75 denier polyester yarns combined with 40 denier elastane yarns. It will be appreciated that other textile substrates can be used and the above textile is exemplary only.

Pre-Washing

The fabric was cleaned to remove any surface finishing oils and waxes from its surface using a recommended pre-cleaning procedure by HeiQ. This procedure ensures a clean fabric free from disturbing residues, with a right pH level and high a hydrophilicity for maximum finishing effects and performance A Datacolor Ahiba IR PRO was used for this purpose with a rotation speed of 30 rpm.

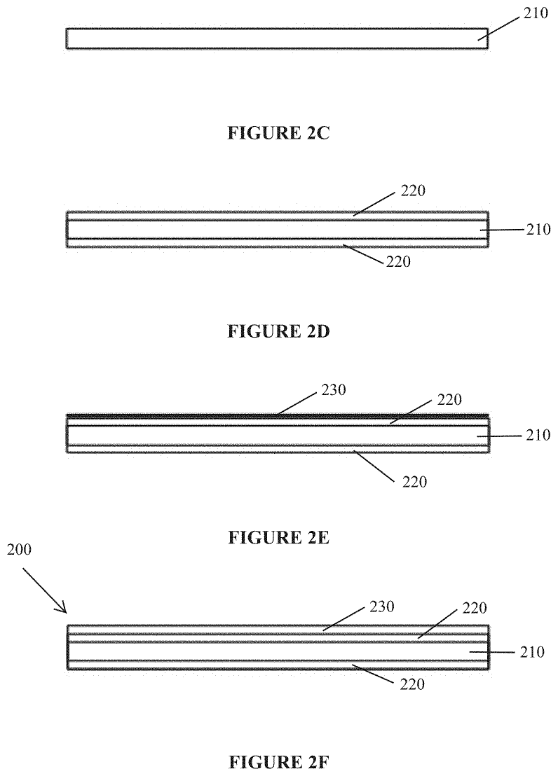

A pre-wash procedure using conducted using a fabric to liquor ratio of 1:10. Liquor consisting of: 1 g/l HeiQ Clean DEC+0.75 g/l HeiQ Complex AYC (in distilled water). The recommended time/temperature ramp shown in FIG. 3 was used. It will be appreciated that any time/temperature ramp may be utilised and any predetermined liquor ratio may also be used.

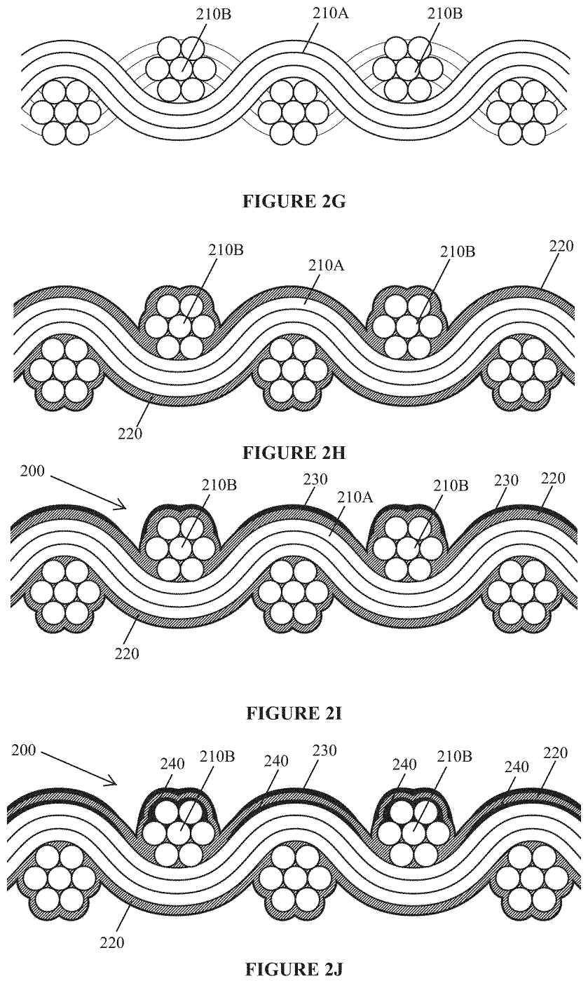

Following the pre-wash procedure, a cleaning & neutralisation step was conducted using a fabric to liquor ratio of 1:10. Liquor consisting of: 4 g/l HeiQ CAG+0.75 g/l HeiQ Complex AYC (in distilled water). The recommended time/temperature ramp showed in FIG. 4 was used. Following this step, a Hot Rinse @65° C. followed by cold rinse (in a large 5 litre beaker) was conducted.

### Plasma Surface Pre-treatment:

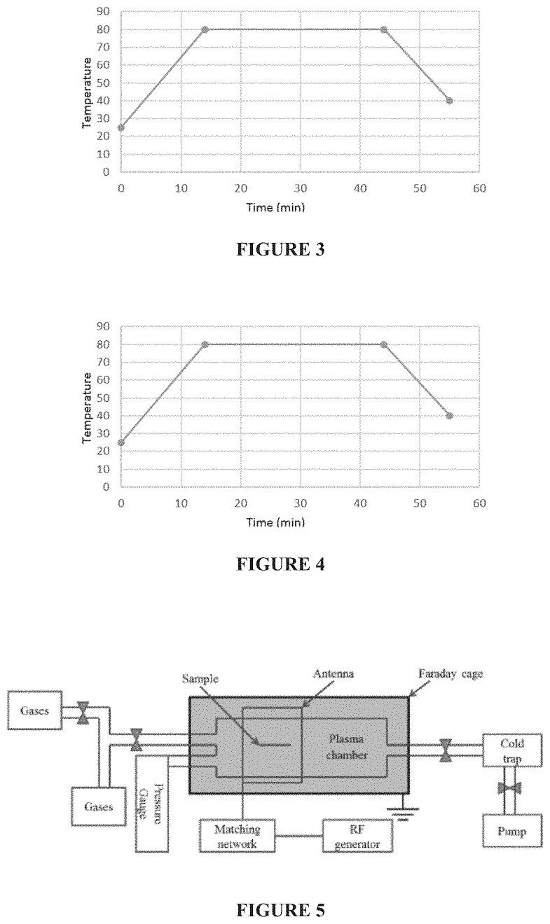

The samples were pre-treated by Argon plasma prior to both cured coating and plasma coating application procedures. A purpose-built, inductively coupled Radio Frequency (RF) 13.56 MHz low pressure plasma system and shown in FIG. 5 was employed to conduct plasma treatment on the fabric samples. A stainless steel frame was custom built to hold the fabric during the plasma treatment. The samples were first treated by argon plasma with power of 100W for 1 minute at 0.08 mbar pressure to activate and clean the surface.

### Application of Hydrophobic Coating Composition to Form Cured Hydrophobic Coating Layer

Two commercially available products from HeiQ were used to produce different cured coatings: HeiQ HM C6 (C6) and HeiQ Barrier ECO DRY (C0). The HMC6 and ECO DRY products were used in combination with a cross-linking agent and with a wetting agent for each test.

Based on average 115 take up weight percent, the corresponding chemical solutions were prepared and filled in a padder machine. Based on an average 115 take up weight percent, the liquor was formulated so to achieve the following final barrier coating weight percent on the fabric: 4 wt % HeiQ Barrier HM-C6, 0.5 wt % HeiQ SAX and 0.2 wt % HeiQ WFR for the C6 coating and 5% HeiQ ECO DRY C0, 1% Hei WFR, 1% HeiQ SAX and 1% Hei Soft Res for the C0 Coating.

Then, the fabrics were passed through the padder at a pressure of 4 bars, 2 meters per minute padding speed for twice. After that, the samples were curing in an oven for 4 min at 140 degree.

Plasma Coating

The purpose-built, inductively coupled RF 13.56 MHz low pressure plasma system used to conduct plasma surface pre-treatment on the fabric samples was also used to apply the plasma coatings. Two monomers: hexamethyldisiloxane (HMDSO) and hexafluorobenzene (HFB) were used for produce plasma hydrophobic coatings. The plasma condition details are shown in Table 1.

TABLE 1
Plasma conditions

| Low-pressure | | | |
|---|---|---|---|
| plasma Power | Pressure | Treatment time: | Monomer |
| 100-150W | 0.1 mbar | 5-15min | HMDSO, HFB |

Contact Angle

Static contact angles were measured using a CAM101/KSV contact angle system using DI water as a probe liquid. The received fabric was hydrophobic as the water droplet absorption time was very fast (less than 1 second). But after either chemical or plasma coatings, all the coated samples become super-hydrophobic where the contact angel is over 150°.

### Water Absorption Test:

A wash tumbling test was developed to test the durability of the coated fabrics. For this test, four specimens (each 10 cm×10 cm) for each plasma treatment were prepared. A seam allowance of 1 cm was marked on the back of each specimen, then the specimen was sewn on the marked line to become a fabric tube. The fabric tubes were then mounted on 10 cm perimeter rubber tubes. Each of the loose ends was taped and then all specimens were placed in a washing machine (Wascator FOM71 CLS) to wash according to a domestic washing and drying procedures for textile testing as shown in Table 2. Polyester ballasts were also added make the total weight 2 kg.

TABLE 2
Washing conditions used

| Temp. ° C. | Wash time | Rinse 1 | Rinse 2 | Rinse 3 | Rinse 4 |
|---|---|---|---|---|---|
| 70 ± 3 | 15 min | 3 min | 3 min | 2 min | 2 min |

After washing, a water absorption rate was calculated to evaluate the durability of the coating, where a small water absorption rate means a higher durable performance of the coating.

Water absorption rate:

$$A = \frac{( Wa - Wb )}{Wb} \times 100 \%$$

Wₐ: the weight of the sample after washing;
W_{b}: the weight of the sample before washing.

### Results

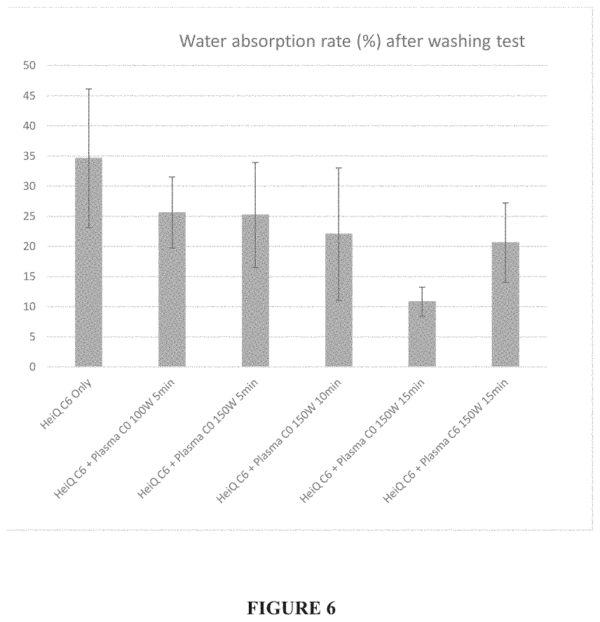

FIG. 6 shows the water absorption rates of different samples where plasma coatings were produced on fabrics comprising the HMC6 cured coating. The combined HMC6 and Plasma C0 coatings had a significant reduction in water absorption rate in comparison to the samples with the HMC6 cured coating only. It can also be seen that samples with a thicker plasma coating (a long treatment time) have lower water adsorption rates, where a 15 min treatment gives the lowest water adsorption rate at about 10.8%.

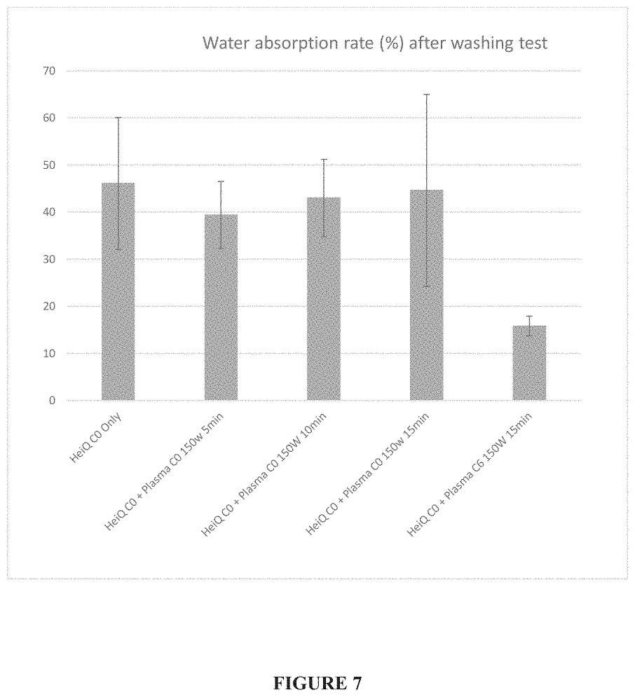

FIG. 7 shows the water absorption rates of different samples where plasma coatings were produced on fabrics comprising the ECO DRY C0 cured coating. The combined ECO DRY C0 and Plasma C0 coating showed a reduction in water absorption rate in comparison to the samples with the ECO DRY C0 cured coating only. It could also be seen that with a thinner plasma coating (shorter treatment time), the water adsorption rates deceased, where a 5 min treatment gave the lowest water adsorption rate of the C0 plasma coatings at about 39.4%. The combined ECO DRY C0 and Plasma C6 coating showed a further reduction in water absorption rate (15.8%) in comparison to fabrics with the ECO DRY C0 cured coating only and also the ECO DRY C0 cured coating and Plasma C0 coating.

In view of the above, it may be desirable to have a plasma treatment time of between 20 seconds to 5 minutes as this may allow for effective processing times while also imparting a desired functionality to the substrate. Although, based on the results of the above, it is preferably to increase the exposure time of the substrate to the plasma and allow for a thicker coating to be applied. Treatment times may also be reduced by increasing at least one of the flow of monomers, a density of the plasma, or a combination thereof. In this way thicker coatings can be applied to substrates more quickly, and thereby reduce overall exposure time. As such, the overall exposure time may be directly related to a flow rate of monomer and rate of polymerisation for any further coatings.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1. A water repellent fibrous substrate comprising:
(i) a cured hydrophobic coating layer located on the fibrous substrate; and
(ii) a hydrophobic plasma polymer coating layer located on the hydrophobic coating layer.

2. The water repellent fibrous substrate according to claim 1, wherein the fibrous substrate is in the form of a fibre, yarn or fabric.

3. The water repellent fibrous substrate according to claim 1, wherein the fibrous substrate comprises cotton, wool, angora, silk, grass, rush, hemp, sisal, coir, straw, bamboo, pina, ramie, and seaweed, polyamide (nylon), polyester, polyolefin, polyacrylonitrile, polyurethane, aramid, acetate and combinations of two or more thereof.

4. The water repellent fibrous substrate according to claim 1, wherein the cured hydrophobic coating layer contains hyperbranched-based polymer, dendrimer, silicone-based polymer, fluorocarbon-based polymer, or combinations thereof.

5. The water repellent fibrous substrate according to claim 1, wherein the hydrophobic plasma polymer coating layer comprises plasma polymerised residues of one or more of hexamethyldisiloxane (HMDSO), hexamethyldisilazane (HMDSN), tetrafluoromethane, octafluorocyclobutane, difluoroacetylene, and hexafluorobenzene (HFB).

6. A method of producing a water repellent fibrous substrate, the method comprising:
(i) providing a fibrous substrate having a cured hydrophobic coating layer thereon; and
(ii) plasma polymerising monomer to form a hydrophobic plasma polymer coating layer located on the cured hydrophobic coating layer.

7. The method according to claim 6 which comprises a step of subjecting the cured hydrophobic coating layer to a hydrophilic plasma treatment so as to form a hydrophilic surface on which the hydrophobic plasma polymer coating layer is to be formed.

8. The method according to claim 6 which comprises a step of subjecting the cured hydrophobic coating layer to argon or helium plasma treatment, followed by hydrophilic plasma treatment to provide a hydrophilic surface on which the hydrophobic plasma polymer coating layer is to be formed.

9. The method according to claim 6 which comprises a step of applying a hydrophobic coating composition to a fibrous substrate and curing the hydrophobic coating composition so as to provide the fibrous substrate having a cured hydrophobic coating layer thereon.

10. A water-repellent substrate comprising;
a substrate having an upper surface;
a water-repellent coating applied to the upper surface of the substrate;
the water-repellent coating having an upper surface; and
wherein the upper surface of the water-repellent coating is formed by a plasma polymerised coating.

11. The water-repellent substrate according to claim 10, wherein the substrate is selected from the group of a; woven, knitted and non-woven.

12. The water-repellent substrate according to claim 10, wherein the water-repellent coating comprises a first coating and a second coating.

13. The water repellent substrate according to claim 10, wherein the water-repellent coating is formed from with at least two coatings.

14. The water repellent substrate according to claim 10, wherein the water repellent coating extends through at least a portion of a structure of the substrate.

15. The water repellent substrate according to claim 10, wherein the coating on the first side comprises plasma polymerised residues of one or more of hexamethyldisiloxane (HMDSO), hexamethyldisilazane (HMDSN), tetrafluoromethane, octafluorocyclobutane, difluoroacetylene, and hexafluorobenzene (HFB).

16. A substrate with a functional coating comprising;
a substrate with a first side and a second side;
the first and second sides of the substrate having a coating applied thereto, and connected through the substrate; and
wherein the coating on the first side of the substrate has at least one of; a higher abrasion resistance, a thicker coating, an improved water-repellency, and a harder finish, relative to the coating on the second side.

17. The substrate according to claim 16, wherein the functional coating is a water-repellent coating.

18. The substrate according to claim 16, wherein the coating on the first side is formed from a coating applied via wet dipping and a coating formed by plasma polymerisation.

19. The substrate according to claim 16, wherein the coating on the first side comprises plasma polymerised residues of one or more of hexamethyldisiloxane (HMDSO), hexamethyldisilazane (HMDSN), tetrafluoromethane, octafluorocyclobutane, difluoroacetylene, and hexafluorobenzene (HFB).

20. The substrate according to claim 16, wherein the substrate is selected from the group of a; woven substrate, non-woven substrate, and a knitted substrate.
